(19) United States
(12) Patent Application Publication
(10) Pub. No.: US 2012/0043283 A1
(43) Pub. Date: Feb. 23, 2012

(54) AERATION APPARATUS, SEAWATER FLUE GAS DESULFURIZATION APPARATUS INCLUDING THE SAME, AND OPERATION METHOD OF AERATION APPARATUS

(76) Inventors: Keisuke SONODA, Tokyo (JP); Shozo NAGAO, Tokyo (JP); Koji IMASAKA, Tokyo (JP); Seiji FURUKAWA, Tokyo (JP); Yoshihiko TSUCHIYAMA, Tokyo (JP)

(21) Appl. No.: 13/206,630

(22) Filed: Aug. 10, 2011

Related U.S. Application Data
(60) Provisional application No. 61/435,476, filed on Jan. 24, 2011.

(30) Foreign Application Priority Data
Aug. 18, 2010 (JP) 2010-183499

(51) Int. Cl. C02F 1/74; B01D 19/00; C02F 101/10

(52) U.S. Cl. 210/758; 261/105; 96/181

(57) ABSTRACT

A first slit 12A formed in a diffuser membrane of aeration diffusers of an aeration apparatus according to the present invention includes a linear reference slit 12a and a branched slit 12b crossing the linear reference slit 12a at a center thereof, and an opening shape of the first slit 12A is deformed due to pressure of air (an amount of air) to be supplied. Therefore, because an opening amount at a crossing 12c of the linear reference slit 12a and the branched slits 12b increases by temporarily increasing the amount of air, elimination of precipitates is facilitated, differently from conventional cases having only linear slits.

### FIELD

The present invention relates to wastewater treatment in a flue gas desulphurization apparatus used in a power plant such as a coal, crude oil, or heavy oil combustion power plant. In particular, the invention relates to an aeration apparatus for aeration used for decarboxylation (air-exposure) of wastewater (used seawater) from a flue gas desulphurization apparatus for desulphurization using a seawater method. The invention also relates to a seawater flue gas desulphurization apparatus including the aeration apparatus and to an operation method of the aeration apparatus.

### BACKGROUND

In conventional power plants that use coal, crude oil, and the like as fuel, combustion flue gas (hereinafter referred to as “gas”) discharged from a boiler is emitted to the air after sulfur oxides (SOₓ) such as sulfur dioxide (SO₂) contained in the flue gas are removed. Known examples of the desulphurization method used in a flue gas desulphurization apparatus for the above desulphurization treatment include a limestone-gypsum method, spray dryer method, and seawater method.

In a flue gas desulphurization apparatus that uses the seawater method (hereinafter referred to as a “seawater flue gas desulphurization apparatus”), its desulphurization method uses seawater as an absorbent. In this method, seawater and flue gas from a boiler are supplied to the inside of a desulfurizer (absorber) having a vertical tubular shape such as a vertical substantially cylindrical shape, and the flue gas is brought into gas-liquid contact with the seawater used as the absorbent in a wet process to remove sulfur oxides. The seawater (used seawater) used as the absorbent for desulphurization in the desulfurizer flows through, for example, a long water passage having an open upper section (Seawater Oxidation Treatment System: SOTS) and is then discharged. In the long water passage, the seawater is decarbonated (exposed to air) by aeration that uses fine air bubbles ejected from an aeration apparatus disposed on the bottom surface of the water passage (Patent documents 1 to 3).

### CITATION LIST

### Patent Literature

Patent Literature 1: Japanese Patent Application Laid-open No. 2006-055779
Patent Literature 2: Japanese Patent Application Laid-open No. 2009-028570
Patent Literature 3: Japanese Patent Application Laid-open No. 2009-028572

### SUMMARY

### Technical Problem

Aeration diffusers used in the aeration apparatus each have a large number of small slits formed in a rubber-made diffuser membrane that covers a base. Such aeration diffusers are generally referred to as “diffuser nozzles.” These aeration diffusers can eject many fine air bubbles of substantially equal size from the slits with the aid of the pressure of the air supplied to the nozzles. Conventionally, in the case of a rubber-made diffuser membrane, the length of the slit is about 1 to 3 millimeters.

When aeration is continuously performed in seawater using the above aeration diffusers, precipitates such as calcium sulfate in the seawater are deposited on the wall surfaces of the slits of the diffuser membranes and around the openings of the slits, causing the gaps of the slits to be narrowed and the slits to be clogged. This results an increase in pressure loss of the diffuser membranes, and the discharge pressure of discharge unit, such as a blower or compressor, for supplying the air to the diffuser is thereby increased, so that disadvantageously the load on the blower or compressor increases.

The occurrence of the precipitates may be due to the following reason. Seawater present outside a diffuser membrane permeates inside the diffuser membrane through its slits and comes into continuous contact with air passing through the slits for a long time. Drying (concentration of the seawater) is thereby facilitated, and the precipitates are deposited.

In view of the above problem, it is an object of the present invention to provide an aeration apparatus that can discharge precipitates generated in the slits of diffuser membranes to the outside of the diffuser membranes, a seawater flue gas desulfurization apparatus including the aeration apparatus, and an operation method of an aeration apparatus.

### Solution to Problem

According to an aspect of the present invention, an aeration apparatus that is immersed in water to be treated and generates fine air bubbles in the water to be treated, includes: an air supply pipe for supplying air through a discharge unit; and an aeration diffuser including a diffuser membrane having a slit, the air being supplied through the slit to the aeration diffuser. An opening shape of the slit is deformed due to pressure of air supplied through the slit.

Advantageously, in the aeration apparatus, the slit has at least a bent portion.

Advantageously, the aeration apparatus further includes a control unit that controls a temporal increase in supply of air at every predetermined time.

Advantageously, in the aeration apparatus, the control unit controls a temporal increase in the supply of air and supply of water to the air supply pipe.

According to another aspect of the present invention, a seawater flue gas desulfurization apparatus includes: a desulfurizer that uses seawater as an absorbent; a water passage that discharges used seawater discharged from the desulfurizer; and any one of the aeration apparatus described above that is disposed in the water passage, and generate fine air bubbles in the used seawater to decarbonate the used seawater.

According to still another aspect of the present invention, an operation method of an aeration apparatus includes: using the aeration apparatus according to any one of claims 1 to 4 that is immersed in water to be treated and used to generate fine air bubbles in water to be treated; and temporarily increasing supply of air at every predetermined time to prevent clogging, when air is supplied through a discharge unit.

Advantageously, in the operation method of an aeration apparatus, water is supplied to an air supply pipe when the supply of the air is temporarily increased or separately.

### Advantageous Effects of Invention

According to the present invention, discharge of precipitates to the outside of diffuser membranes can be facilitated in the slits of the diffuser membranes of the aeration apparatus.

### BRIEF DESCRIPTION OF DRAWINGS

FIG. 1 is a schematic diagram of a seawater flue gas desulphurization apparatus according to an embodiment.

FIG. 2A is a plan view of aeration diffusers.

FIG. 2B is a front view of the aeration diffusers.

FIG. 3 is a schematic diagram of the inner structure of an aeration diffuser.

FIG. 4A is a schematic diagram of a shape of a first slit of the aeration diffuser according to the embodiment.

FIG. 4B is a schematic diagram of a shape of a second slit of the aeration diffuser according to the embodiment.

FIG. 4C is a schematic diagram of a shape of a third slit of the aeration diffuser according to the embodiment.

FIG. 4D is a schematic diagram of a shape of a fourth slit of the aeration diffuser according to the embodiment.

FIG. 4E is a schematic diagram of a shape of a fifth slit of the aeration diffuser according to the embodiment.

FIG. 4F is a schematic diagram of a shape of a sixth slit of the aeration diffuser according to the embodiment.

FIG. 4G is a schematic diagram of a shape of a seventh slit of the aeration diffuser according to the embodiment.

FIG. 4H is a schematic diagram of a shape of an eighth slit of the aeration diffuser according to the embodiment.

FIG. 4I is a schematic diagram of a shape of a ninth slit of the aeration diffuser according to the embodiment.

FIG. 5A depicts the outflow of air (humid air having a low degree of saturation), the inflow of seawater, and a state of concentrated seawater in a slit of a diffuser membrane.

FIG. 5B depicts the outflow of air, the inflow of seawater, and states of concentrated seawater and precipitates in the slit of the diffuser membrane.

FIG. 5C depicts the outflow of air, the inflow of seawater, and states of concentrated seawater and precipitates (when precipitates grow) in the slit of the diffuser membrane.

FIG. 6 is a schematic diagram of an aeration apparatus according to the embodiment.

FIG. 7 is a schematic diagram of the aeration apparatus according to the embodiment.

FIG. 8 is a graph of a relation between a passage of time and pressure loss fluctuation of a diffuser membrane when an amount of air is temporarily increased.

### DESCRIPTION OF EMBODIMENTS

Hereinafter, the present invention will be described in detail with reference to the drawings. However, the present invention is not limited to embodiments described below. The components in the following embodiments include those readily apparent to persons skilled in the art and those substantially similar thereto.

### Embodiments

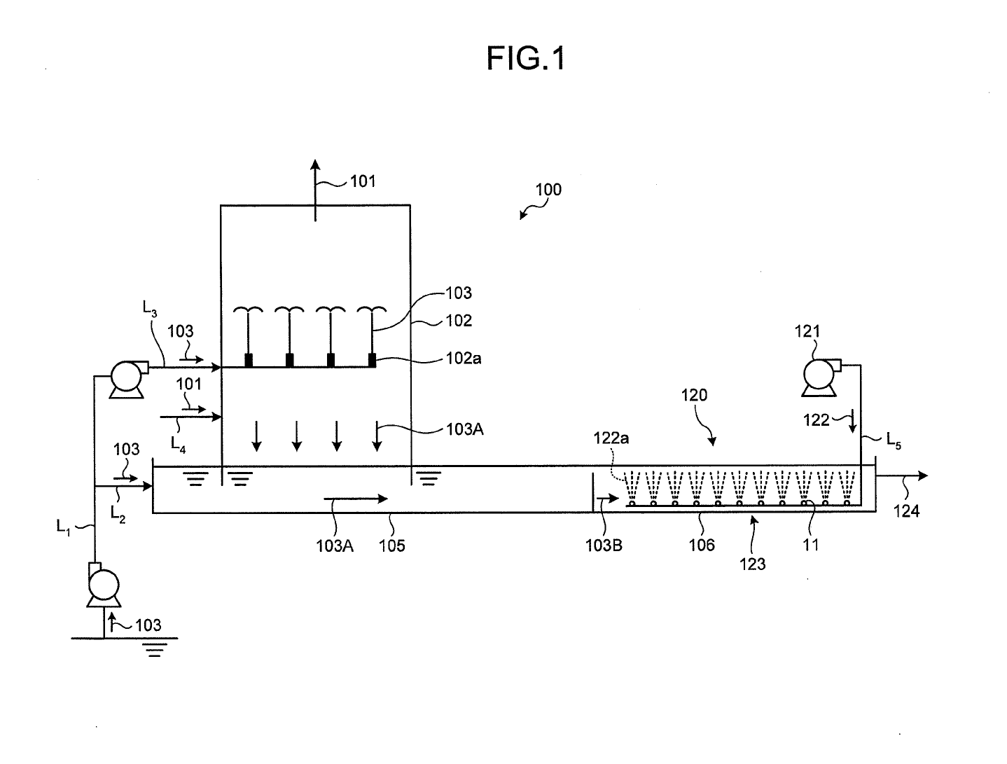

An aeration apparatus and a seawater flue gas desulphurization apparatus according to embodiments of the present invention will be described with reference to the drawings. FIG. 1 is a schematic diagram of the seawater flue gas desulphurization apparatus according to one embodiment.

As shown in FIG. 1, a seawater flue gas desulphurization apparatus 100 includes: a flue gas desulphurization absorber 102 in which flue gas 101 and seawater 103 comes in gas-liquid contact to desulphurize SO₂ into sulfurous acid (H₂SO₃); a dilution-mixing basin 105 disposed below the flue gas desulphurization absorber 102 to dilute and mix used seawater 103A containing sulfur compounds with dilution seawater 103; and an oxidation basin 106 disposed on the downstream side of the dilution—mixing basin 105 to subject diluted used seawater 103B to water quality recovery treatment.

In the seawater flue gas desulphurization apparatus 100, the seawater 103 is supplied through a seawater supply line L₁, and part of the seawater 103 is used for absorption, i.e., is brought into gas-liquid contact with the flue gas 101 in the flue gas desulphurization absorber 102 to absorb SO₂ contained in the flue gas 101 into the seawater 103. The used seawater 103A that has absorbed the sulfur components in the flue gas desulphurization absorber 102 is mixed with the dilution seawater 103 supplied to the dilution-mixing basin 105 disposed below the flue gas desulphurization absorber 102. The diluted used seawater 103B diluted and mixed with the dilution seawater 103 is supplied to the oxidation basin 106 disposed on the downstream side of the dilution-mixing basin 105. Air 122 supplied from an oxidation air blower 121 is supplied to the oxidation basin 106 from aeration diffusers 123 to recover the quality of the seawater, and the resultant water is discharged to the sea as treated water 124.

In FIG. 1, reference numeral 102a represents spray nozzles for injecting seawater upward as liquid columns; 120 represents an aeration apparatus; 122a represents air bubbles; L₁ represents a seawater supply line; L₂ represents a dilution seawater supply line; L₃ represents a desulphurization seawater supply line; L₄ represents a flue gas supply line; and L₅ represents an air supply line.

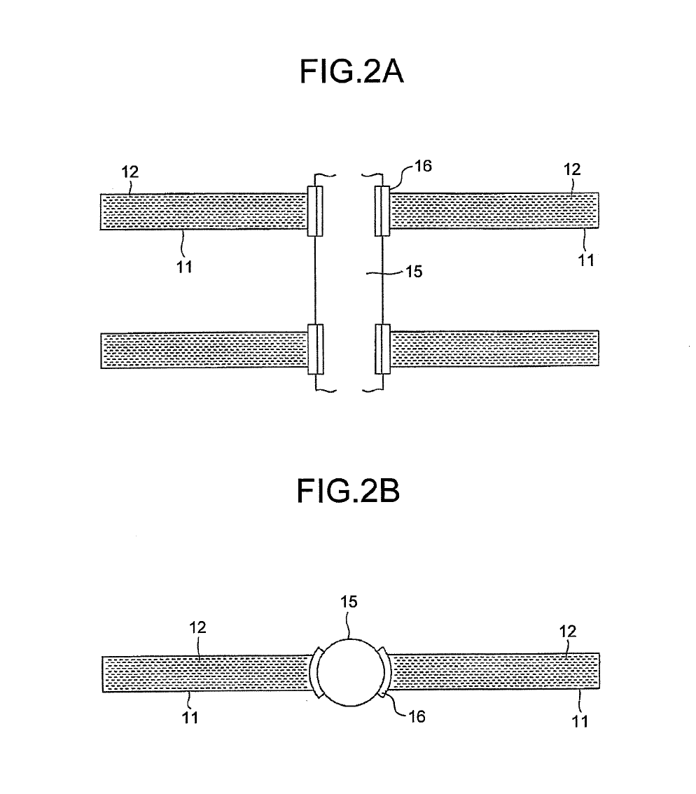

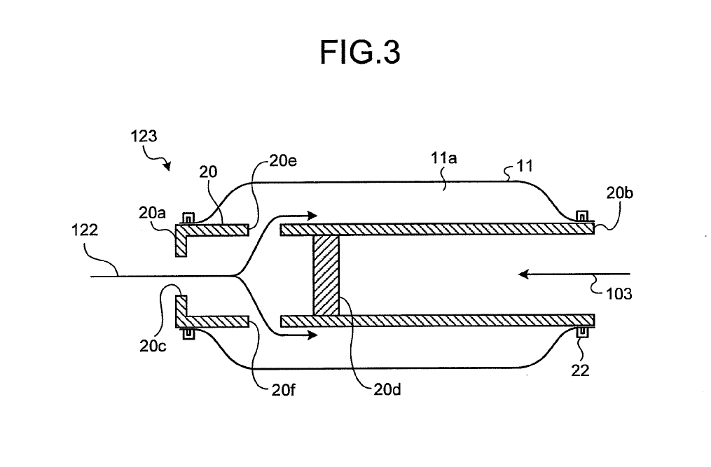

The structure of the aeration diffusers 123 is described with reference to FIGS. 2A, 2B, and 3.

FIG. 2A is a plan view of the aeration diffusers; FIG. 2B is a front view of the aeration diffusers; and FIG. 3 is a schematic diagram of the inner structure of an aeration diffuser.

As shown in FIGS. 2A and 2B, each aeration diffuser 123 has a large number of small slits 12 formed in a rubber-made diffuser membrane 11 that covers the circumference of a base and is generally referred to as a “diffuser nozzle.” In such an aeration diffuser 123, when the diffuser membrane 11 is expanded by the pressure of the air 122 supplied from the air supply line L₅, the slits 12 open to allow a large number of fine air bubbles of substantially equal size to be ejected.

As shown in FIGS. 2A and 2B, the aeration diffusers 123 are attached through flanges 16 to headers 15 provided in a plurality of (eight in the present embodiment) branch pipes (not shown) branched from the air supply line L₅. In consideration of corrosion resistance, resin-made pipes, for example, are used as the branch pipes and the headers 15 disposed in the diluted used seawater 103B.

For example, as shown in FIG. 3, each aeration diffuser 123 is formed as follows. A substantially cylindrical support body 20 that is made of a resin in consideration of corrosion resistance to the diluted used seawater 103B is used, and a rubber-made diffuser membrane 11 having a large number of slits 12 formed therein is fitted on the support body 20 so as to cover its outer circumference. Then the left and right ends of the diffuser membrane 11 are fastened with fastening members 22 such as wires or bands.

The slits 12 described above are closed in a normal state in which no pressure is applied thereto. In the seawater flue gas desulphurization apparatus 100, because the air 122 is continuously supplied, the slits 12 are constantly in an open state.

A first end 20a of the support body 20 is attached to a header 15 and allows the introduction of the air 122, and the support body 20 has an opening at its second end 20b that allows the introduction of the seawater 103.

In the support body 20, the side close to the first end 20a is in communication with the inside of the header 15 through an air inlet port 20c that passes through the header 15 and the flange 16. The inside of the support body 20 is partitioned by a partition plate 20d disposed at some axial position in the support body 20, and the flow of air is blocked by the partition plate 20d. Air outlet holes 20e and 20f are formed in the side surface of the support body 20 and disposed on the header 15 side of the partition plate 20d. The air outlet holes 20e and 20f allow the air 122 to flow between the inner circumferential surface of the diffuser membrane 11 and the outer circumferential surface of the support body, i.e., into a pressurization space 11a for pressurizing and expanding the diffuser membrane 11. Therefore, the air 122 flowing from the header 15 into the aeration diffuser 123 flows through the air inlet port 20c into the support body 20 and then flows through the air outlet holes 20e and 20f formed in the side surface into the pressurization space 11a, as shown by arrows in FIG. 3.

The fastening members 22 fasten the diffuser membrane 11 to the support body 20 and prevent the air flowing through the air outlet holes 20e and 20f from leaking from the opposite ends.

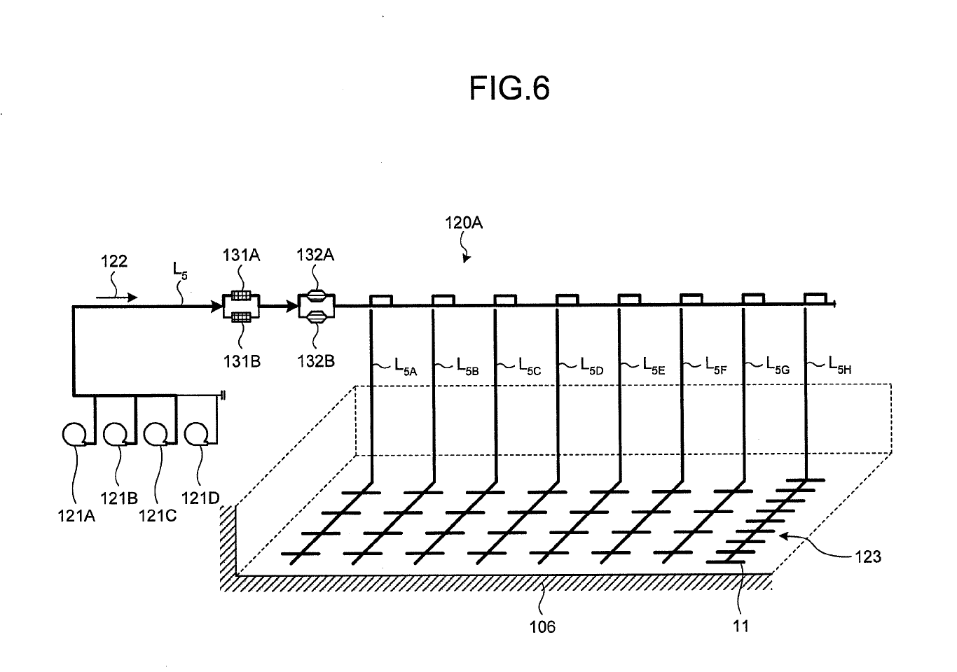

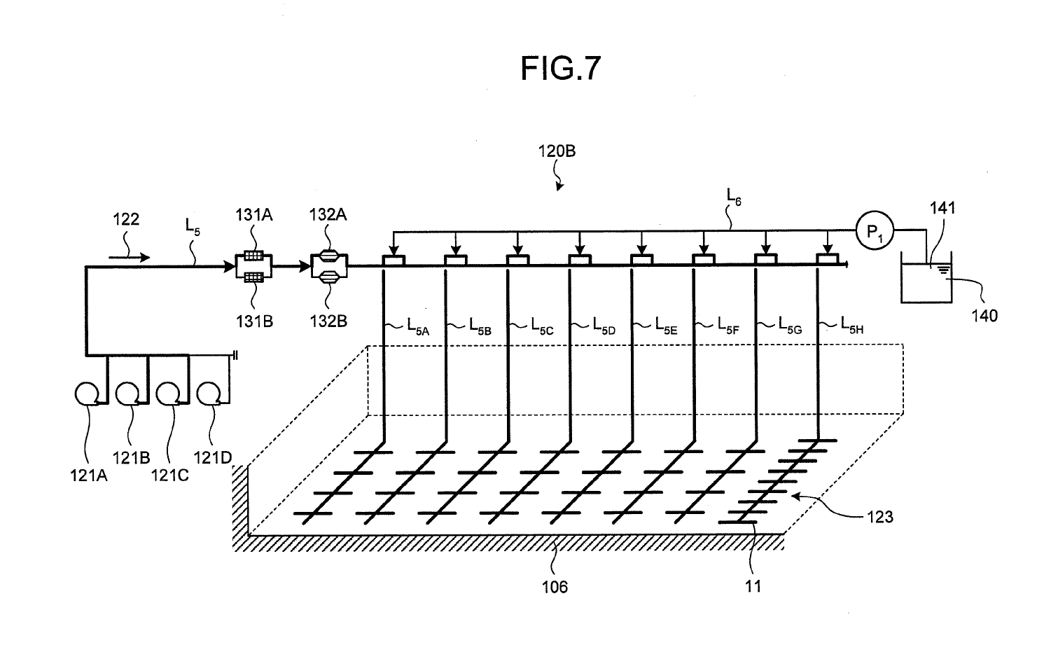

In the aeration diffuser 123 configured as above, the air 122 flowing from the header 15 through the air inlet port 20c flows through the air outlet holes 20e and 20f into the pressurization space 11a. Since the slits 12 are closed in the initial state, the air 122 is accumulated in the pressurization space 11a to increase the inner pressure. The increase in the inner pressure of the pressurization space 11a causes the diffuser membrane 11 to expand, and the slits 12 formed in the diffuser membrane 11 are thereby opened, so that fine bubbles of the air 122 are injected into the diluted used seawater 103B. Such fine air bubbles are generated in all the aeration diffusers 123 to which air is supplied through branch pipes L₅A to L₅H and the headers 15 (see FIGS. 6 and 7).

The aeration apparatus according to the present embodiment will next be described. In the present invention, an opening shape of the slit 12 formed in the diffuser membrane 11 is deformed due to the pressure of air (an amount of air) to be supplied, thereby discharging precipitates generated in the slits 12 to the outside of the diffuser membrane 11.

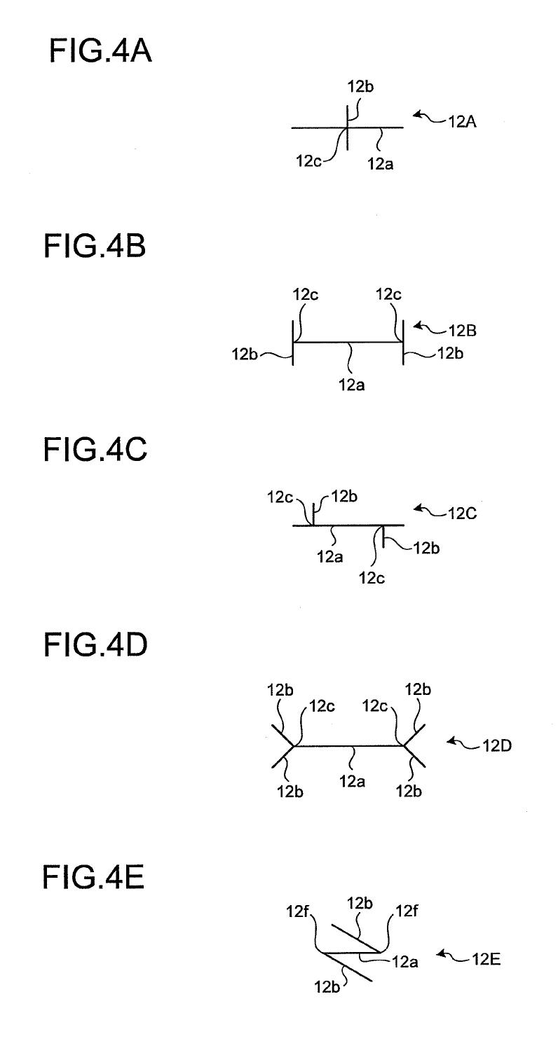

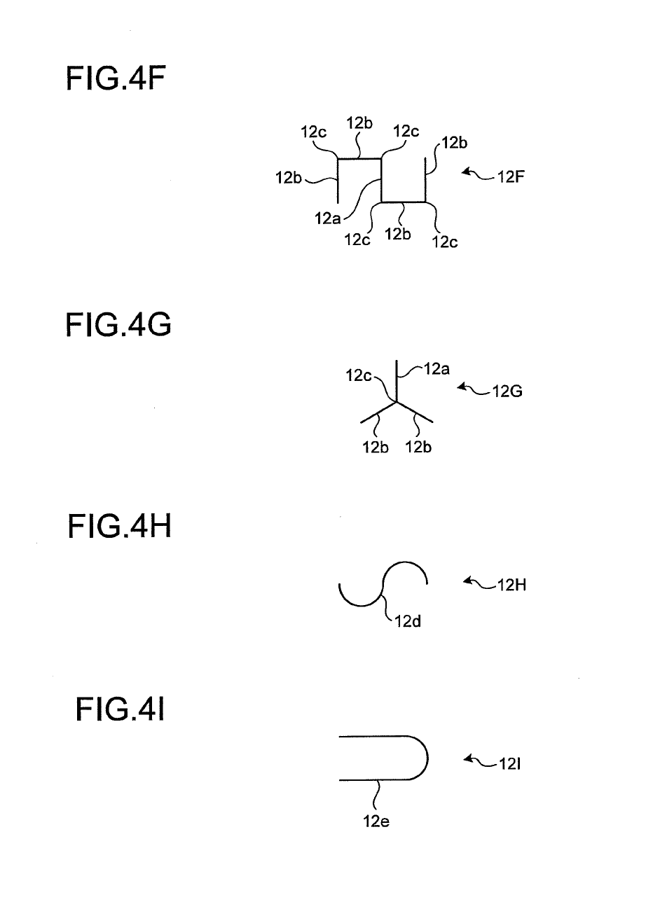

FIGS. 4A to 4I depict shapes of various slits formed in the diffuser membrane of the aeration diffuser according to the present embodiment.

FIG. 4A is a schematic diagram of a shape of a first slit of the aeration diffuser according to the present embodiment.

As shown in FIG. 4A, the shape of a first slit 12A is formed by a linear reference slit 12a and a branched slit 12b crossing the linear reference slit 12a at a center thereof. An opening amount of the first slit 12A changes due to the pressure of the air 122 (an amount of air) to be supplied.

In this manner, because the opening amount at a bent portion of a crossing 12c of the linear reference slit 12a and the branched slit 12b increases, when the pressure of air to be supplied becomes high (when the amount of air increases), discharge of the precipitates to the outside of the diffuser membrane is facilitated, differently from conventional cases having only linear slits.

The salt concentration in seawater is 3.4%, and 3.4% of salts are dissolved in 96.6% of water. The salt includes 77.9% of sodium chloride, 9.6% of magnesium chloride, 6.1% of magnesium sulfate, 4.0% of calcium sulfate, 2.1% of potassium chloride, and 0.2% of other salts.

Of these salts, calcium sulfate is deposited first as seawater is concentrated (dried), and the precipitation threshold value of the salt concentration in seawater is about 14%.

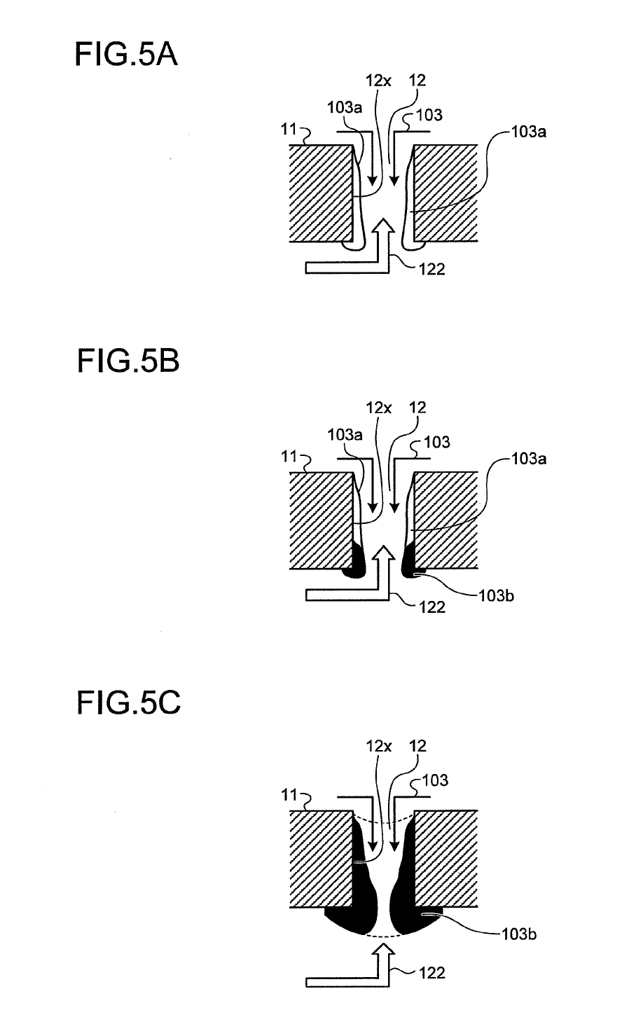

A mechanism in which precipitates are deposited in the slits 12 is explained with reference to FIGS. 5A to 5C.

FIG. 5A depicts the outflow of air (humid air having a low degree of saturation), the inflow of seawater, and a state of concentrated seawater in the slit of the diffuser membrane. FIG. 5B depicts the outflow of air, the inflow of seawater, and states of concentrated seawater and precipitates in the slit of the diffuser membrane. FIG. 5C depicts the outflow of air, the inflow of seawater, and states of concentrated seawater and precipitates (when precipitates grow) in the slit of the diffuser membrane.

In the present invention, the slits 12 are cuts formed in the diffuser membrane 11, and the gap of each slit 12 serves as a discharge passage of air.

The seawater 103 is in contact with slit wall surfaces 12× that form the passage. The introduction of the air 122 causes the seawater 103 to be dried and concentrated to form concentrated seawater 103a. A precipitate 103b is then deposited on the slit wall surfaces 12× and clogs the passage in the slits 12.

FIG. 5A depicts a state in which salt content in seawater is gradually concentrated to form the concentrated seawater 103a due to low relative humidity of the air 122 (low degree of saturation). However, even if the concentration of the seawater is initiated, deposition of calcium sulfate and the like does not occur when the salt concentration in the seawater is about 14% or less.

In the state shown in FIG. 5B, the precipitate 103b is generated in portions of the concentrated seawater 103a in which the salt concentration in the seawater locally exceeds 14%. In this state, the amount of the precipitate 103b is very small. Therefore, although the pressure loss when the air 122 passes through the slits 12 increases slightly, the air 122 can pass through the slits 12.

Therefore, in this state, precipitation is forcibly removed by generating pressure fluctuation as described later, thereby enabling an operation for a long time.

On the other hand, in the state shown in FIG. 5C, because the concentration of the concentrated seawater 103a has proceeded further, a clogged (plugged) state due to the precipitate 103b is formed, and the pressure loss becomes high. Even in this state, the passage of the air 122 remains. Even in this state, precipitates are forcibly removed by generating pressure fluctuation as described later, thereby enabling an operation for a long time.

Therefore, in the present embodiment, as shown in FIG. 4A, it is set that an opening shape of the slit can be deformed due to the pressure of air (an amount of air) to be supplied, thereby preventing clogging.

FIG. 4B is a schematic diagram of a shape of a second slit of the aeration diffuser according to the present embodiment.

As shown in FIG. 4B, the shape of a second slit 12B is formed by the linear reference slit 12a and branched slits 12b formed so as to be orthogonal to the opposite ends of the linear reference slit 12a. The opening shape of the second slit 12B is deformed due to the pressure of the air 122 (an amount of air) to be supplied.

In this manner, because the opening amount at the bent portions of the crossings 12c of the linear reference slit 12a and the branched slits 12b formed at the ends thereof increases when the pressure of air to be supplied becomes high (when the amount of air increases), discharge of the precipitates to the outside of the diffuser membrane is facilitated, differently from conventional cases having only linear slits.

FIG. 4C is a schematic diagram of a shape of a third slit of the aeration diffuser according to the present embodiment.

As shown in FIG. 4C, the shape of a third slit 12C is formed by the linear reference slit 12a and branched slits 12b formed so as to be branched just before the opposite ends of the linear reference slit 12a. The opening shape of the third slit 12C is deformed due to the pressure of the air 122 (an amount of air) to be supplied.

In this manner, because the opening amount at the bent portions of the crossings 12c of the linear reference slit 12a and the branched slits 12b formed at the ends thereof increases when the pressure of air to be supplied becomes high (when the amount of air increases), discharge of the precipitates to the outside of the diffuser membrane is facilitated, differently from conventional cases having only linear slits.

FIG. 4D is a schematic diagram of a shape of a fourth slit of the aeration diffuser according to the present embodiment.

As shown in FIG. 4D, the shape of a fourth slit 12D is formed by the linear reference slit 12a and branched slits 12b, 12b formed so as to be branched in a V shape at the opposite ends of the linear reference slit 12a. The opening shape of the fourth slit 12D is deformed due to the pressure of the air 122 (an amount of air) to be supplied.

In this manner, because the opening amount at the bent portions of the crossings 12c of the linear reference slit 12a and the V-shaped branched slits 12b, 12b formed at the ends thereof increases when the pressure of air to be supplied becomes high (when the amount of air increases), discharge of the precipitates to the outside of the diffuser membrane is facilitated, differently from conventional cases having only linear slits.

FIG. 4E is a schematic diagram of a shape of a fifth slit of the aeration diffuser according to the present embodiment.

As shown in FIG. 4E, the shape of a fifth slit 12E is formed by the linear reference slit 12a and branched slits 12b, 12b formed so as to be branched at a sharp angle at the opposite ends of the linear reference slit 12a. The opening shape of the fifth slit 12E is deformed due to the pressure of the air 122 (an amount of air) to be supplied.

In this manner, because the opening amount at bent portions 12f at the opposite ends of the linear reference slit 12a increases when the pressure of air to be supplied becomes high (when the amount of air increases), discharge of the precipitates to the outside of the diffuser membrane is facilitated, differently from conventional cases having only linear slits.

FIG. 4F is a schematic diagram of a shape of a sixth slit of the aeration diffuser according to the present embodiment.

As shown in FIG. 4F, the shape of a sixth slit 12F is formed by the linear reference slit 12a and branched slits 12b, 12b formed so as to be branched in an L-shape at the opposite ends of the linear reference slit 12a. The opening shape of the sixth slit 12F is deformed due to the pressure of the air 122 (an amount of air) to be supplied.

In this manner, because the opening amount at the bent portions 12f of the linear reference slit 12a and the L-shaped branched slits 12b, 12b formed at the ends thereof increases when the pressure of air to be supplied becomes high (when the amount of air increases), discharge of the precipitates to the outside of the diffuser membrane is facilitated, differently from conventional cases having only linear slits.

FIG. 4G is a schematic diagram of a shape of a seventh slit of the aeration diffuser according to the present embodiment.

As shown in FIG. 4G, the shape of a seventh slit 12G is formed by the linear reference slit 12a and branched slits 12b, 12b formed so as to be branched in a V-shape at the end of the linear reference slit 12a. The opening shape of the seventh slit 12G is deformed due to the pressure of the air 122 (an amount of air) to be supplied.

In this manner, because the opening amount at the crossing 12c of the linear reference slit 12a and the V-shaped branched slits 12b, 12b formed at the end thereof increases when the pressure of air to be supplied becomes high (when the amount of air increases), discharge of the precipitates to the outside of the diffuser membrane is facilitated, differently from conventional cases having only linear slits.

FIG. 4H is a schematic diagram of a shape of an eighth slit of the aeration diffuser according to the present embodiment.

As shown in FIG. 4H, the shape of an eighth slit 12H is formed by an S-shaped slit 12d. The opening shape of the eighth slit 12H is deformed due to the pressure of the air 122 (an amount of air) to be supplied.

In this manner, because the opening amount at a bent portion of a curve of the S-shaped slit 12d increases when the pressure of air to be supplied becomes high (when the amount of air increases), discharge of the precipitates to the outside of the diffuser membrane is facilitated, differently from conventional cases having only linear slits.

FIG. 4I is a schematic diagram of a shape of a ninth slit of the aeration diffuser according to the present embodiment.

As shown in FIG. 4I, the shape of a ninth slit 12I is formed by a U-shaped slit 12e. The opening shape of the ninth slit 12I is deformed due to the pressure of the air 122 (an amount of air) to be supplied.

At the bent portion, because the opening amount at a curved portion of the U-shaped slit 12e increases when the pressure of air to be supplied becomes high (when the amount of air increases), discharge of the precipitates to the outside of the diffuser membrane is facilitated, differently from conventional cases having only linear slits.

FIGS. 6 and 7 are schematic diagrams of the aeration apparatus according to the present embodiment.

As shown in FIG. 6, an aeration apparatus 120A according to the present embodiment is immersed in diluted used seawater (not shown), which is water to be treated, and generates fine air bubbles in the diluted used seawater.

This aeration apparatus includes: an air supply line L₅ that supplies the air 122 from blowers 121A to 121D serving as discharge units; aeration diffusers 123 each including the diffuser membrane 11 having slits for supplying air including water, and a control unit (not shown) that controls a temporal increase in the supply of the air 122 at every predetermined time.

Two cooling units 131A and 131B and two filters 132A and 132B are provided in the air supply line L₅. The air compressed by the blowers 121A to 121D is thereby cooled and then filtrated.

Normally, three of the four blowers are used for operation, and one of them is a reserve blower. Since the aeration apparatus must be continuously operated, only one of the two cooling units 131A and 131B and only one of the two filters 132A and 132B are normally used, and the others are used for maintenance.

In the present embodiment, the control unit issues a command to temporarily increase the supply of the air 122 at every predetermined time.

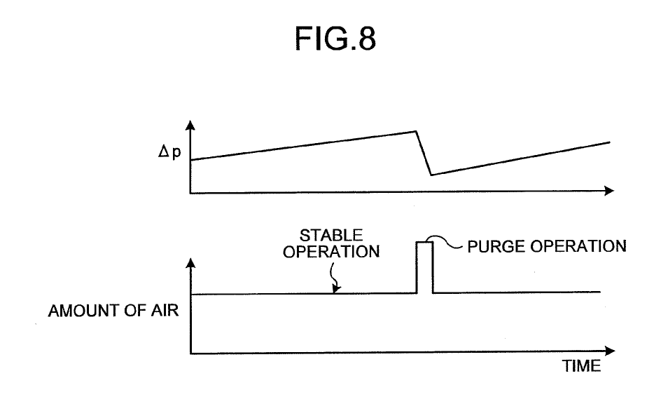

FIG. 8 is a graph of a passage of time and pressure fluctuation.

As shown in FIG. 8, during a stable operation, after a predetermined time has passed, a purge operation for increasing the amount of air is performed for a predetermined time.

In this manner, because the supply of the air 122 is increased at every predetermined time and pressure fluctuation occurs (the amount of air temporarily increases) to increase expansion of the diffuser membrane 11, precipitates of calcium sulfate deposited in the slits 12 are discharged to the outside, and the slit returns to a normal state.

As a result, it can be prevented that the slits 12 are clogged and the gap of the slits 12 becomes narrow due to precipitation of calcium sulfate in a continuous operation, thereby preventing pressure loss of the diffuser membrane 11.

An interval of the increase can be appropriately changed corresponding to the precipitation state of precipitates; however, preferably, the increase is made once in one or two days.

This is because precipitates can be easily discharged to the outside of the diffuser membrane by increasing the supply of air at an early stage of initial precipitation to cause pressure fluctuation passing through the slits 12.

To realize the temporal increase, for example, in the aeration apparatus 120A shown in FIG. 6, when three blowers 121A to 121C are normally operated, a reserve blower 121D can be further driven to supply a large amount of air 122 to the air supply line L₅.

That is, the amount of air to be introduced into the aeration diffusers 123 is increased by activating the reserve blower 121D. As a result, the slits 12 of the diffuser membrane 11 open largely, and calcium sulfate can be discharged to the seawater side and removed.

Accordingly, it can be prevented that the slits 12 are clogged and the gap of the slits 12 becomes narrow due to precipitation of calcium sulfate, thereby preventing pressure loss of the diffuser membrane 11.

When a capacity of blower is not sufficient, a predetermined purge condition can be set so that precipitates are pushed out and blown away from the slits 12 by using an additional blower.

Further, as shown in FIG. 7, in an aeration apparatus 120B according to the present embodiment, a water supply line L₆ that supplies fresh water 141 to the air supply line L₅ is provided. It suffices that a control unit (not shown) then controls a temporal increase in the supply of the air 122 and controls the supply of the fresh water 141 to the air supply line L₅.

In this manner, by supplying the fresh water 141, it is introduced into the aeration diffusers 123. Accordingly, the slits 12 of the diffuser membrane 11 are cleaned, and precipitates such as calcium sulfate adhered to the slits 12 can be dissolved and removed.

As a result, it can be prevented that the slits 12 are clogged and the gap of the slits 12 becomes narrow due to precipitation of calcium sulfate, thereby preventing pressure loss of the diffuser membrane 11.

In the present embodiment, while the fresh water 141 is used as the supplied water, instead of fresh water, seawater (for example, the seawater 103 from the diluted seawater supply line L₂, the used seawater 103A in a dilution-mixing basin 105, or the diluted used seawater 103B in the oxidation basin 106) and water vapor can be used.

In the present embodiment, while seawater has been exemplified as the water to be treated, the present invention is not limited thereto. For example, plugging caused by deposition of contamination components such as sludge on diffuser slits (membrane slits) can be prevented in the aeration apparatus for aeration of contaminated water in decontamination processing, and thus the aeration apparatus can be stably operated for a long time.

In the present embodiment, while tube-type aeration diffusers have been exemplified for explaining the aeration apparatus, the present invention is not limited thereto. For example, the invention is applicable to disk-type and flat-type aeration apparatuses and to diffusers made of ceramic or metal.

### INDUSTRIAL APPLICABILITY

As described above, in the aeration apparatus according to the present invention, precipitates generated in the slits of the diffuser membrane of the aeration apparatus can be discharged to the outside of the diffuser membranes. For example, when applied to a seawater flue gas desulphurization apparatus, the aeration apparatus can be continuously operated in a stable manner for a long time.

### REFERENCE SIGNS LIST

11 diffuser membrane
12 slit
12A to 12I first slit to ninth slit
100 seawater flue gas desulphurization apparatus
102 flue gas desulphurization absorber
103 seawater
103A used seawater
103B diluted used seawater
105 dilution-mixing basin
106 oxidation basin
120, 120A, 120B aeration apparatus
123 aeration diffuser

1. An aeration apparatus that is immersed in water to be treated and generates fine air bubbles in the water to be treated, the aeration apparatus comprising:
an air supply pipe for supplying air through a discharge unit; and
an aeration diffuser including a diffuser membrane having a slit, the air being supplied through the slit to the aeration diffuser, wherein
an opening shape of the slit is deformed due to pressure of air supplied through the slit.

2. The aeration apparatus according to claim 1, wherein the slit has at least a bent portion.

3. The aeration apparatus according to claim 1, further comprising a control unit that controls a temporal increase in supply of air at every predetermined time.

4. The aeration apparatus according to claim 3, wherein the control unit controls a temporal increase in the supply of air and supply of water to the air supply pipe.

5. A seawater flue gas desulfurization apparatus comprising:
a desulfurizer that uses seawater as an absorbent;
a water passage that discharges used seawater discharged from the desulfurizer; and
the aeration apparatus according to claim 1 that is disposed in the water passage, and generate fine air bubbles in the used seawater to decarbonate the used seawater.

6. An operation method of an aeration apparatus, the method comprising:
using the aeration apparatus according to claim 1 that is immersed in water to be treated and used to generate fine air bubbles in water to be treated; and
temporarily increasing supply of air at every predetermined time to prevent clogging, when air is supplied through a discharge unit.

7. The operation method of an aeration apparatus according to claim 6, wherein water is supplied to an air supply pipe when the supply of the air is temporarily increased or separately.
